(19) United States
(12) Patent Application Publication
(10) Pub. No.: US 2016/0310978 A1
(43) Pub. Date: Oct. 27, 2016

(54) Sprayer Boom System with Multi-direction Spray Section Activation Control

(71) Applicant: CNH Industrial America LLC, New Holland, PA (US)

(72) Inventors: Roy A. Bittner, Cato, WI (US); Nathan Paul Brooks, Manitowoc, WI (US)

(21) Appl. No.: 14/697,117

(22) Filed: Apr. 27, 2015

(51) Int. Cl. B05B 12/00; A01M 7/00; B05B 9/00; B05B 1/20; A01G 25/16; A01G 25/09

(52) U.S. Cl. CPC B05B 12/002; A01G 25/16; A01G 25/097; B05B 9/007; B05B 1/20; A01M 7/0071; A01M 7/0089

(57) ABSTRACT

The boom system allows for multi-direction section activation control, allowing left-to-right and right-to-left deactivation, left-to-right and right-to-left activation, and piecemeal or discontinuous deactivation and activation of each section independent of other sections. A first set of deactivation/activation buttons may be arranged at a joystick grip and allow for left-to-right deactivation and right-to-left activation of sections. A second set of spray deactivation/activation buttons may be arranged at the joystick grip and allow for right-to-left deactivation and left-to-right activation of sections. A third set of spray deactivation/activation buttons may be arranged at a touchscreen and allow for individual deactivation/activation independent of position of the sections with respect to the boom and each other.

### FIELD OF THE INVENTION

The invention relates generally to agricultural product application equipment or applicators such as self-propelled and other sprayers and, in particular, to an application boom such as a sprayer boom system with multi-direction section activation control which may include dual indexing joystick grip controls.

### BACKGROUND OF THE INVENTION

Application booms such as sprayer boom systems on sprayers or other applicator vehicles are known that have multiple application or spray sections extending across a width of the booms. Over time, booms on sprayers or other applicators have gotten wider to increase machine efficiency and these wider booms have larger or more application or spray sections than with previous booms. As the booms have gotten wider, more area is covered in a single pass of the applicator, which increases a potential for overlap application and thus applying previously treated sections or applying product over objects or land portions that would preferably not be treated. Accordingly, at times, it can be beneficial to turn off some of the application sections. Some boom systems have sections that can be turned off manually, which takes a lot of time and requires an operator to leave the cab of the sprayer and physically rotate a handle of a valve feeding the sections to turn off. Efforts have been made to allow operators to turn off sections without leaving the vehicle cab. These efforts sometimes include a section turn-off button that turns off sections in a single predetermined turn-off direction starting at one end of the boom and moving toward the other end of the boom and a section turn-on button that turns the sections back on in a single predetermined turn-on pattern, in the opposite direction. With the recent larger booms, even though an operator may not have to leave the applicator cab, the turning off and on of the sections in the single allowed direction can take a lot of time. Plus, only turning-off sections from one end of the boom require the operator to plan a particular travel direction and path that places the corresponding end of the boom with the turned-off sections in the zone to avoid application, which may not have been the travel direction and path the operator would have otherwise chosen.

### SUMMARY OF THE INVENTION

An application system such as a sprayer boom system is provided for an agricultural applicator which may be a sprayer that is configured for substantial versatility in section deactivation and activation control. The boom system allows for multi-direction section activation control, which may include dual indexing joystick grip controls for deactivation from either end of a boom and may include a touchscreen HMI (human machine interface) for piecemeal deactivation and activation of sections, from within an applicator cab. This provides a boom system with sections that can be deactivated and activated according to a custom pattern to fit a particular situation and custom modify the deactivation/activation pattern while on the go. The pattern adjustments provide application zones that can be width adjusted by narrowing from or widening toward either end of the boom, shifted or indexed toward either end of the boom, or split into two or more spray application zones by piecemeal deactivation/activation of spray sections. This allows an operator to adjust application patterns to correspond a desired travel path instead of having to adjust a travel path to correspond to limited sectional control of the applicator.

According to one aspect of the invention, the application boom system is a sprayer boom system that is provided with multi-direction spray section activation control. The sprayer boom system has a boom extending transversely relative to a self-propelled agricultural sprayer with the boom having a boom center section for supporting the boom from the self-propelled agricultural sprayer, a left boom arm extending to the left away from the center section, and a right boom arm extending to the right away from the center section. A spraying system has multiple spray sections defined along the boom selectively delivering product stored at the self-propelled agricultural sprayer for release onto an agricultural field at locations corresponding to positions of the multiple spray sections. Each of the multiple spray sections may include multiple spray nozzles or a bank of nozzles. The multiple spray sections include multiple left boom arm spray sections arranged at the left boom arm, including a left outer spray section arranged at an outer end of the left boom arm farthest from the boom center section and a left inner spray section arranged at an inner end of the left boom arm closest to the boom center section. Multiple right boom arm spray sections are arranged at the right boom arm and include a right outer spray section arranged at an outer end of the right boom arm farthest from the boom center section and a right inner spray section arranged at an inner end of the right boom arm closest to the boom center section. A center spray section is arranged at the boom center section. A spray section control system controls the spraying system to selectively activate and deactivate ones of the multiple spray sections to selectively permit spray release of the product from activated ones of the multiple spray sections and prevent spray release of the product from deactivated ones of the multiple spray sections. The spray section control system is configured to deactivate spray sections according to a multi-pattern deactivation strategy. The multi-pattern deactivation strategy includes a first deactivation pattern during which spray sections are deactivated with a left-to-right deactivation direction pattern from the left outer spray section toward the right outer spray section. A second deactivation pattern deactivates spray sections with a right-to-left deactivation direction pattern from the right outer spray section toward the left outer spray section. A third deactivation pattern deactivates a spray section with an intermediate bi-directional pattern from an intermediate spray section between the left and right outer spray sections toward at least one of the left and right outer spray sections.

According to another aspect of the invention, the spray section control system is configured to activate spray sections according to a multi-pattern activation strategy. The multi-pattern activation strategy includes a first activation pattern during which spray sections are activated with a right-to-left activation direction. A second activation pattern activates spray sections with a left-to-right activation direction. A third activation pattern activates spray sections with an intermediate bi-directional pattern from an intermediate spray section between the left and right outer spray sections toward at least one of the left and right outer spray sections.

According to another aspect of the invention, the spray section control system may include a first set of spray deactivation/activation buttons configured for deactivating and activating the spray sections according to the first deactivation and activation patterns. A second set of spray deactivation/activation buttons may be configured for deactivating and activating the spray sections according to the second deactivation and activation patterns. The first set of spray deactivation/activation buttons may include a left-start deactivation button configured so that sequentially pressing the left-start deactivation button sequentially deactivates the spray sections from the left outer spray section toward the right outer spray section. The first set of spray deactivation/activation buttons may include a right-start activation button configured so that sequentially pressing the right-start activating button sequentially activates the spray sections from a right-most deactivated spray section toward the left outer spray section. The second set of spray deactivation/activation buttons may include a right-start deactivation button configured so that sequentially pressing the right-start deactivation button sequentially deactivates the spray sections from the right outer spray section toward the left outer spray section. The second set of spray deactivation/activation buttons may include a left-start activation button configured so that sequentially pressing the left-start activating button sequentially activates the spray sections from a left-most deactivated spray section toward the right outer spray section.

According to another aspect of the invention, the first and second sets of spray deactivation/activation buttons may be arranged at a grip of a joystick control of the self-propelled agricultural sprayer. The first set of spray deactivation/activation buttons may be defined by a pair of pad segments of a first spray control button and the second set of spray deactivation/activation buttons are defined by a pair of pad segments of a second spray control button. The spray section control system further comprises a full activation button configured to activate all of the spray sections in a single actuation of the full activation button.

According to another aspect of the invention, the spray section control system may include a third set of spray deactivation/activation buttons configured for deactivating and activating the spray sections according to the third deactivation and activation patterns. The third set of spray deactivation/activation buttons may include multiple spray section valve buttons corresponding to the multiple sections of the boom system. Each of the multiple spray sections can be deactivated and activated independently of the other spray sections.

According to another aspect of the invention, the third set of spray deactivation/activation buttons may be defined by graphical buttons displayed on a touchscreen of the spray section control system. Each of the graphical buttons of the third set of spray deactivation/activation buttons may change visually to provide a visual indication of a closed condition or an open condition of a spray section feed valve feeding the respective spray section with the visual indication of the closed condition and open condition of the spray section feed valve corresponding to a deactivated and activated condition of the respective spray section.

According to another aspect of the invention, a spraying session of a self-propelled agricultural sprayer is initiated, which may include activating all of multiple spray sections of a self-propelled agricultural sprayer. The multiple spray sections may include a left outer spray section arranged at an outer end of a left boom arm and a right outer spray section arranged at an outer end of a right boom arm. One of the left and right outer spray sections may be deactivated as an initial spray deactivation event during a first spray deactivation procedure of the spraying session. The other one of the left and right outer spray sections may be deactivated as an initial spray deactivation event during a second spray deactivation procedure of the spraying session. During the first deactivation procedure, multiple spray sections are deactivated according a first deactivation pattern. The first deactivation pattern may be one during which spray sections are deactivated with a left-to-right deactivation direction pattern from the left outer spray section toward the right outer spray section. During the second deactivation procedure, multiple spray sections are deactivated according a second deactivation pattern. The second deactivation pattern may be one during which spray sections are deactivated with a right-to-left deactivation direction pattern from the right outer spray section toward the left outer spray section. A third deactivation procedure may be performed during which spray sections are deactivated with an intermediate bi-directional pattern from an intermediate spray section between the left and right outer spray sections toward at least one of the left and right outer spray sections.

According to another aspect of the invention, a spraying session of a self-propelled agricultural sprayer to spray a product on an agricultural field is initiated, which may include activating all of multiple spray sections of a boom of a self-propelled agricultural sprayer. The multiple spray sections may include a left outer spray section arranged at an outer end of a left boom arm of the boom, a right outer spray section arranged at an outer end of a right boom arm of the boom, and an intermediate spray section arranged between the left and right outer spray sections. A determination may be made as to which of the left outer spray section, the right outer spray section, and the intermediate spray section should be deactivated during a deactivation procedure of the spraying session based on a potential overlap of a portion of the boom with a previously sprayed portion of the agricultural field as a potential overlap spray section. One of the left outer spray section, the right outer spray section, and the intermediate spray section corresponding to the determined potential overlap spray section is deactivated. A first deactivation procedure may be performed by sequentially deactivating multiple spray sections according to a left-to-right deactivation direction pattern starting by deactivating the left outer spray section and deactivating adjacent spray sections toward the right outer spray section. A second deactivation procedure may be performed by sequentially deactivating multiple spray sections according to a right-to-left deactivation direction pattern starting by deactivating the right outer spray section and deactivating adjacent spray sections toward the left outer spray section. A third deactivation procedure may be performed by sequentially deactivating multiple spray sections according to an intermediate bi-directional pattern starting by deactivating the intermediate spray section and deactivating adjacent spray sections toward at least one of the left and right outer spray sections.

Other aspects, objects, features, and advantages of the invention will become apparent to those skilled in the art from the following detailed description and accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Preferred exemplary embodiments of the invention are illustrated in the accompanying drawings in which like reference numerals represent like parts throughout.

FIG. 1 is a side elevation of a self-propelled sprayer with a sprayer boom system with multi-direction section activation control according to the present invention;

FIG. 2 is a front elevation of a sprayer boom system with multi-direction section activation control according to the present invention;

FIG. 3 is a simplified partially schematic pictorial view of a control system;

FIG. 4 is a simplified partially schematic top plan view of the sprayer boom system of FIG. 2;

FIG. 5 is a simplified partially schematic top plan view of a joystick grip of the control system of FIG. 3;

FIG. 6 is a simplified screenshot of a touchscreen of the control system of FIG. 3;

FIG. 7 is a simplified partially schematic top plan view of portions of the sprayer boom system of FIG. 4; and

FIG. 8 is another simplified partially schematic top plan view of portions of the sprayer boom system of FIG. 4.

### DETAILED DESCRIPTION OF THE PREFERRED EMBODIMENTS

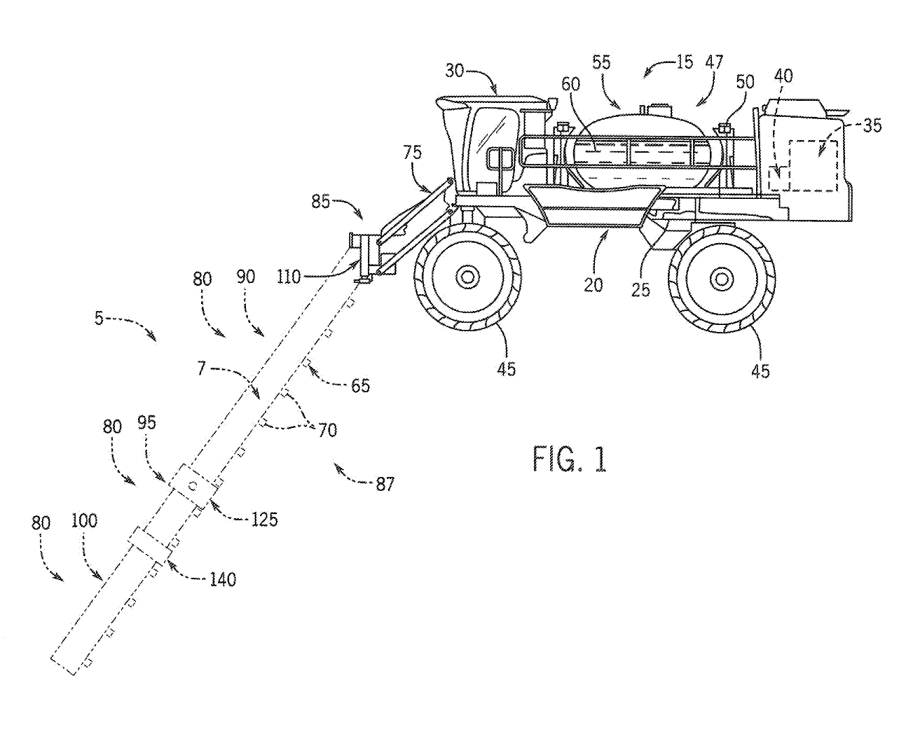

Referring now to the drawings and specifically to FIG. 1, a sprayer boom system 5 is provided that includes boom 7 with multi-direction section activation control, explained in greater detail elsewhere herein, and is shown for use with an agricultural applicator. The agricultural applicator is a machine that deposits, for example, liquid as well as dry and gaseous product, above and below ground, pre-emerge and post-emergence or sprouting of the crop, which includes operations such as seeding, inter-seeding, fertilizing and application of, for example, herbicides, fungicides, and insecticides as well as soil conditioners, growth retardants and other agents, such as by way of various toolbar attachments, planters, anhydrous ammonia applicators, and others. The agricultural applicator may be a sprayer and is shown here as a self-propelled agricultural sprayer vehicle or self-propelled sprayer 15. Although sprayer 15 is shown as a front-mounted boom self-propelled sprayer, it is understood that self-propelled versions of sprayer 15 can have either front-mounted, mid-mount, or rear-mounted booms, such as those available from CNH Industrial, including the Miller Nitro and Condor Series sprayers and New Holland Guardian Series sprayers, as well as pull-type or towed sprayers, boom-less sprayers, tiered booms, and detachable sprayers.

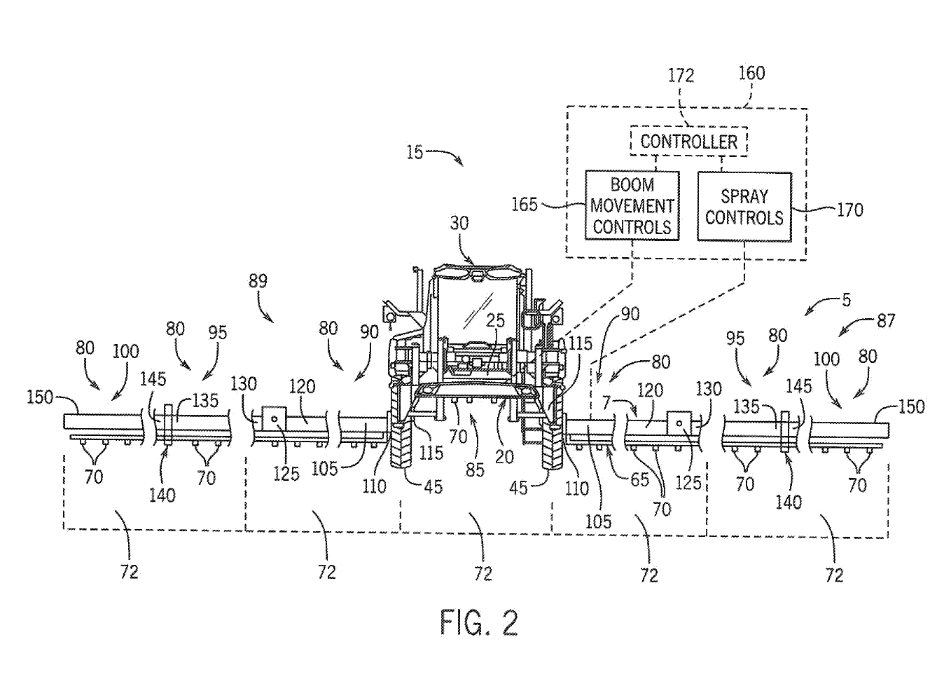

Still referring to FIG. 1, sprayer 15 includes chassis 20 having chassis frame 25 that supports various assemblies, systems, and components. These various assemblies, systems, and components include cab 30, engine 35, and hydraulic system 40. Hydraulic system 40 receives power from engine 35 and includes at least one hydraulic pump which may be in a hydrostatic arrangement for providing hydraulic pressure for operating hydraulic components within the hydraulic system 40. For sprayers with hydrostatic drives, hydraulic motors are operably connected to the hydraulic pump(s) for rotating wheels 45. In mechanical drive applications, a mechanical transmission receives power from engine 35 and delivers power for rotating wheels 45 by way of power-transmitting driveline components such as drive shafts, differentials, and other gear sets in portal, drop boxes, or other housings. An application system, shown as a spraying system or spray system 47, includes storage containers such as rinse tank 50 storing water or a rinsing solution and product tank 55 that stores a volume of product 60 for delivery onto an agricultural field with sprayer 15. Product 60 includes any of a variety of agricultural liquid products, such as various pesticides, herbicides, fungicides, liquid fertilizers, and other liquids including liquid suspensions beneficial for application onto agricultural fields. A product delivery pump conveys product 60 from product tank 55 through plumbing components such as interconnected pieces of tubing and through a boom tubing system 65 for release out of application or spray nozzles 70 that are spaced from each another along the width of boom 7 during spraying operations of sprayer 15. Referring now to FIG. 2, groups or banks of multiple adjacent spray nozzles 70 define multiple application sections shown as spray sections 72 of spray system 47. Spray sections 72 are defined along boom 7 and selectively deliver product 60 for release onto an agricultural field at locations corresponding to positions of activated spray sections 72, as explained in greater detail elsewhere herein. Boom 7 is connected to chassis 20 with lift arm assembly 75 (FIG. 1) that is configured to move the boom 7 up and down for adjusting the height of application of the product 60.

Still referring to FIG. 2, boom 7 includes multiple boom segments 80 connected longitudinally to provide the corresponding width of the assembled boom 7. Boom segments 80 include center section 85 and left and right boom arms 87, 89 extending in opposite directions from center section 85. Left and right boom arms 87, 89 have multiple segments with pairs of primary boom segments 90, secondary boom segments 95, and breakaway boom segments 100 extending in opposite directions along the respective left and right boom arms 87, 89, mirrored about a longitudinal axis of the sprayer 15. The corresponding left and right segments of the pairs of primary, secondary, and breakaway boom segments 90, 95, 100 are substantially identical, so only one will be described, with the description applying to both the left and right segments of left and right boom arms 87, 89. Primary boom segment 90 has a primary boom inner end 105 that is connected with hinge 110 to center section outer end 115, with hinge 110 configured to allow for generally rearward horizontal pivoting of the boom primary, secondary, and breakaway segments 90, 95, 100 toward the chassis 20 when folding boom 7 to achieve a stored position. Primary boom segment 90 extends from primary boom inner end 105 away from center section 85 to primary boom outer end 120. Hinge 125 is arranged between primary boom outer end 120 and secondary boom inner end 130 and is configured to allow for folding the secondary and breakaway segments 95, 100 relative to primary boom segment 90 to achieve the stored position. For horizontal folding of secondary and breakaway segments 95, 100 against the primary boom segment 90, the hinge 125 allows horizontal pivoting of the secondary and breakaway segments 95, 100 toward primary boom segment 90. For vertical folding of secondary and breakaway segments 95, 100 against the primary boom segment 90, the hinge 125 allows vertical pivoting of the secondary and breakaway segments 95, 100 toward the primary boom segment 90. Secondary boom segment 95 extends from secondary boom inner end 130 away from primary boom segment 90 to secondary boom outer end 135. Breakaway joint 140 is arranged between secondary boom outer end 135 and breakaway boom inner end 145 and is configured to allow for momentary deflecting of the breakaway boom segment 100 away from its outwardly extended position during collisions with the crops, the ground, and/or other obstacles. Breakaway boom segment 100 extends from breakaway boom inner end 145 away from secondary boom segment 95 to breakaway boom outer end 150. In the stored position of boom 7, the secondary and breakaway boom segments 95, 100 are folded against the primary boom segment 90. The primary boom segment 90 is folded toward chassis 20 so that the breakaway boom outer end 150 is near the primary boom inner end 105 tucked toward the front of sprayer 15 with the primary boom outer end 120 and secondary boom inner end 130 tucked toward the back of sprayer 15.

Still referring to FIG. 2, control system 160 includes various control subsystems including boom position control system 165 configured to control movements of boom 7 such as height adjustments and folding and unfolding procedures. Control system 160 also includes an application control system, shown as spray section control system 170, that is configured to selectively deactivate and activate spray sections 72, as explained in greater detail elsewhere herein.

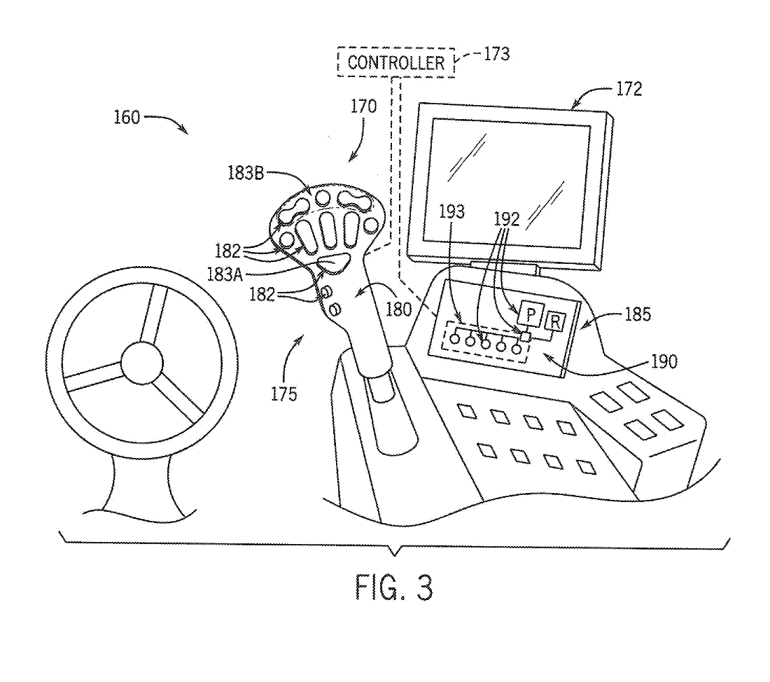

Referring now to FIG. 3, control system 160 has at least one master controller or machine controller, shown as controller(s) 172. Controller(s) 172 includes a microprocessor and may be implemented as a programmable logic controller (PLC) other industrial computer, along with corresponding software and suitable memory for storing such software and hardware including interconnecting conductors for power and signal transmission and communication for controlling electronic, electro-mechanical, and hydraulic components of the sprayer 15. Communication may be done through one or more serial bus systems such as a CAN (controller area network) bus(es) between controller 172 and various intelligent devices as well as sensors, actuators, and/or other components of sprayer 15 for monitoring and controlling the corresponding systems and components of the sprayer 15, which may be established as nodes on the bus. The CAN bus(es) may implement an ISO or other suitable specification or protocol. In this way, control system 160 is configured for controlling steering, speed, braking, shifting, and other operations of the sprayer 15 in addition to the height and folding operations of the boom for the boom position control system 165 and the spray section deactivation/activation and related controls of spray section control system 170.

Still referring to FIG. 3, control system 160 has multiple operator control interfaces that allow for operator control of the systems and components of sprayer 15. The operator control interfaces may include a VT (virtual terminal) or field computer 173, joystick 175, and monitor 185 with a touchscreen 190 as an HMI. Although shown as a single HMI, it is understood that multiple HMI's may be implemented such as an in-cab HMI and another at a load station, or a portable HMI via an electronic tablet application program or dedicated HHD (hand held device) either wireless or tethered to control system 6. Field computer 173 may be configured for controlling precision agriculture-type procedures, as well as various components and systems of the sprayer 15. Joystick 175 includes grip 180 with various grip buttons 182 for controlling corresponding functions of sprayer 15 including movement characteristics such as range and speed controls, as well as functions of the boom position control and spray section control systems 165, 170. Grip buttons 182 include a master button 183A that turns on or activates all the spray sections 72 when pressed once and when pressed again will shut off or deactivate all the spray sections 72. Grip spray control buttons 183B are configured for indexing and controlling the deactivation and activation of the spray sections 72. Touchscreen 190 has various buttons displayed as icons or graphical buttons 192 including graphical spray control buttons 193 that also control the deactivation and activation of the spray sections 72. Thus, an operator may implement various requests through the field computer 173, joystick 175, and touchscreen 190 by way of controller(s) 172 communicating through the CAN bus for controlling functions of the sprayer 15, including controlling the boom position and spray section control system 165, 170.

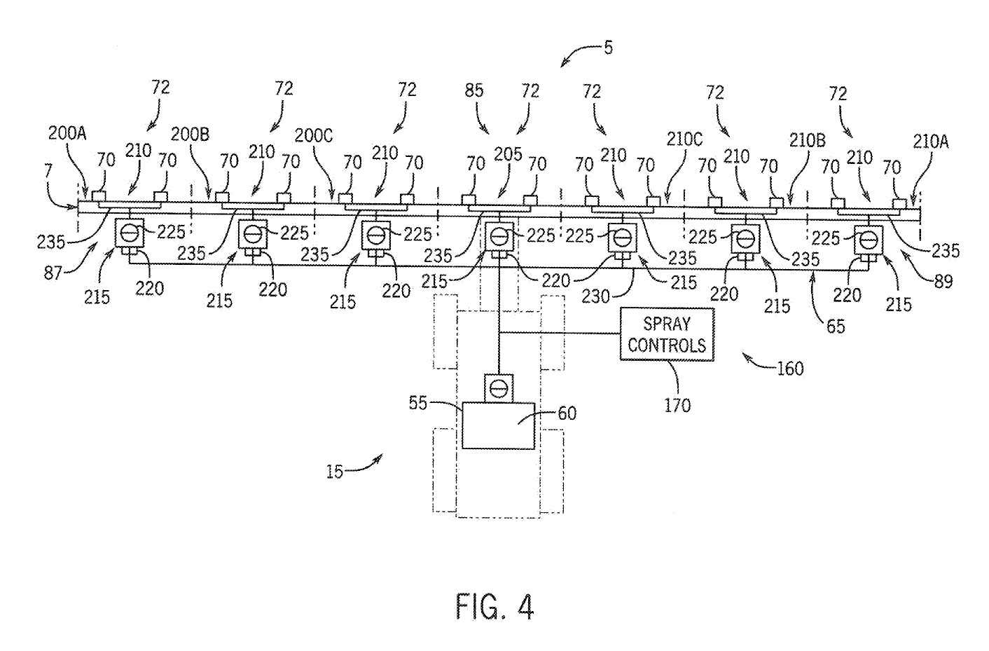

Referring now to FIG. 4, spray control system 170 allows for controlling deactivating and activating the spray sections 72 according to multiple patterns including custom patterns to fit a particular situation and modify the deactivation/activation pattern on the go. Spray sections 72 include outer sections at the ends of left and right boom arms 87, 89 and multiple intermediate spray sections arranged between the outer sections. Spray sections 72 are shown with multiple left boom arm spray sections 200 shown as having left outer spray section 200A arranged at the outer end of left boom arm 87. Left intermediate spray section 200B is arranged adjacent to and inwardly of left outer spray section 200A. Left inner spray section 200C is arranged adjacent to and inwardly of left intermediate spray section 200B, at an inner end of left boom arm 87 closest to boom center section 85. Center spray section 205 is arranged at the boom center section 85, between the left and right boom arms 87, 89. Multiple right boom arm spray sections 210 are shown as having a right outer spray section 210A arranged at the outer end of right boom arm 89. Right intermediate spray section 210B is arranged adjacent to and inwardly of right outer spray section 210A. Right inner spray section 210C is arranged adjacent to and inwardly of right intermediate spray section 210B, at an inner end of right boom arm 89 closest to boom center section 85.

Referring now to FIGS. 3 and 4, by way of pressing buttons on joystick grip 180 (FIG. 3) and/or touchscreen 190 (FIG. 3), the left, center, and right spray sections 200, 205, 210 (FIG. 4) are selectively deactivated and activated according to multi-pattern deactivation and activation strategies or different patterns, such of which may be random or piecemeal deactivation and activation. Pressing buttons on joystick grip 180 (FIG. 3) and/or touchscreen 190 (FIG. 3) controls a respective valve shown as spray section feed valve 215 (FIG. 4) by energizing an actuator 220 to move a valve body 225 between open and closed positions. The open and closed positions of spray section feed valve 215 respectively permit and prevent product flow from a common product feed line 230 into nozzle lines 235 that deliver product 60 to spray nozzles 70. Spray section feed valve 215 may be an electromechanically actuated ball valve, another electromechanically actuated valve, or may be a valve that is otherwise remotely actuated such as by way of pneumatic or other pressures.

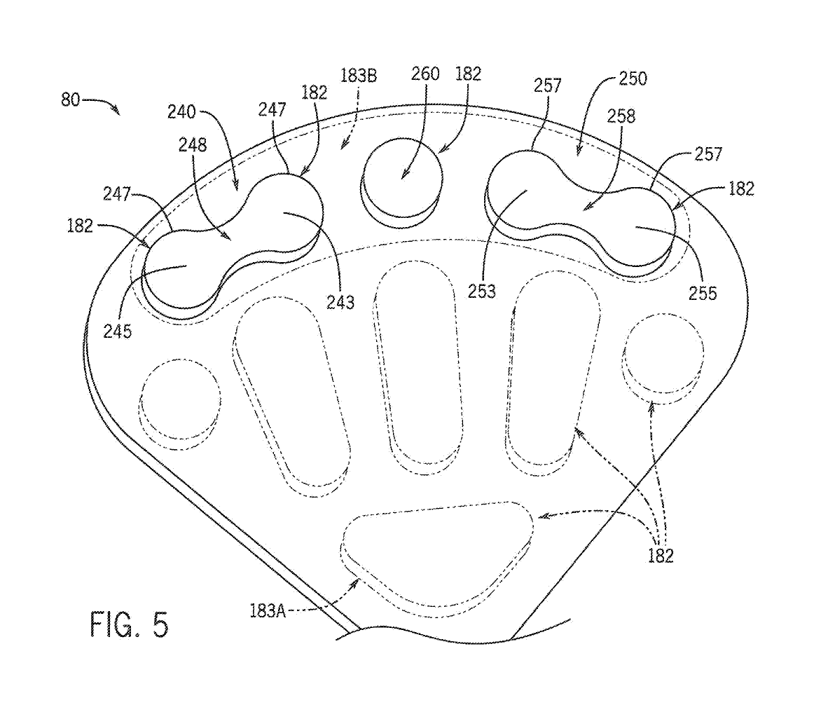

Referring now to FIG. 5, joystick grip 180 has a first set of deactivation/activation buttons 240 which includes left-start deactivation button 243 and right-start activation button 245. Left-start and right-start deactivation and activation buttons 243, 245 are shown defined by a pair of pad segments 247 of spray control button 248. Left-start deactivation button 243 is configured by way of spray control system 170 so that sequentially pressing left-start deactivation button 243 sequentially actuates respective spray section feed valves 215 in an order that deactivates the spray sections 72 from left outer spray section 200A (FIG. 4) to right outer spray section 210A. This provides a first deactivation pattern as a left-to-right deactivation direction pattern. Right-start activation button 245 is configured by way of spray control system 170 so that sequentially pressing right-start activation button 245 sequentially activates the spray sections from a right-most deactivated spray section 72 toward the left outer spray section 200A.

A second set of deactivation/activation buttons 250 includes right-start deactivation button 253 and left-start activation button 255. This provides a first deactivation pattern as a right-to-left activation direction pattern. Right-start and left-start deactivation and activation buttons 253, 255 are shown defined by a pair of pad segments 257 of spray control button 258. Right-start deactivation button 253 is configured by way of spray control system 170 so that sequentially pressing right-start deactivation button 253 sequentially actuates respective spray section feed valves 215 (FIG. 4) in an order that deactivates the spray sections 72 from right outer spray section 210A sequentially toward left our spray section 200A. This provides a second deactivation pattern as a right-to-left deactivation direction pattern. Left-start activation button 255 is configured by way of spray control system 170 so that sequentially pressing left-start activation button 255 sequentially activates the spray sections from a left-most deactivated spray section 72 toward the right outer spray section 210A (FIG. 4). This provides a second activation pattern as a left-to-right activation direction pattern. Both the left-to-right and right-to-left deactivation and activation direction patterns can be implemented during one or more deactivation procedures of a single spraying session by way of the first and second sets of deactivation/activation buttons 240, 250. This allows for narrowing a spray application zone of sprayer 15 inwardly from either or both of the left or right outer ends of boom 7, widening the spray application zone of sprayer 15 outwardly toward either or both of the left or right outer ends of boom 7. This can be done by transversely shifting or indexing the entire application zone to the right or the left while maintaining the application zone width or simultaneously adjusting the width of the spray application zone. Full activation button 260 is configured by way of spray control system 170 so that pressing full activation button 260 a single time activates all of the spray sections 72 along the boom 7.

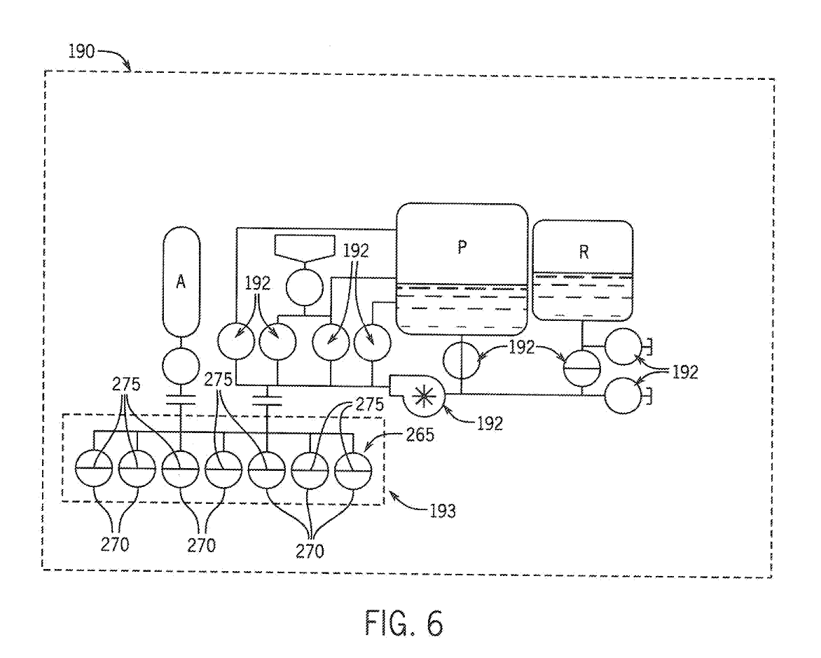

Referring now to FIG. 6, a third set of deactivation/activation buttons 265 is arranged on touchscreen 190 as a set of graphical buttons shown as spray section valve buttons 270. Each spray section valve button 270 can be individually pressed to independently control its respective spray section feed valve 215 for deactivating or activating the particular spray section 72 fed by the spray section feed valve 215. An operator can choose an order in which to press the spray section valve buttons 270 to narrow a spray application zone of sprayer inwardly from either or both of the left or right outer ends of boom 7, widen the spray application zone of sprayer 15 outwardly toward either or both of the left or right outer ends of boom 7, and/or shift or index the entire application zone to the right or the left. An operator can press one or more intermediate spray section valve buttons 270 to split the spray application zone into two or more spray application zones by piecemeal deactivation/activation of spray sections 72. Spray section valve buttons 270 are shown configured to change visually to provide a visual indication of valve status or a closed condition or an open condition of the corresponding spray section feed valves 215. Spray section valve buttons 270 have graphical representations of valve bodies with bars 275 that are arranged horizontally or perpendicularly relative to longitudinal axes of the nozzle lines 235 when closed and vertical or aligned with the longitudinal axes of the nozzles lines 235 when open. Color of spray section valve buttons 270 can also change to indicate closed or open conditions of the spray section feed valves 215. These visual indications can correspond to valve status whether the valve conditions have been changed by actuating the spray section feed valves 215 by deactivation/activation buttons 240, 245, full activation button 260, or spray section valve buttons 270.

During use, one of the left and right outer spray sections 200A, 210A may be deactivated as an initial spray deactivation event during a first spray deactivation procedure of the spraying session. The other one of the left and right outer spray sections 200A, 210A may be deactivated as an initial spray deactivation event during a second spray deactivation procedure of the spraying session. A determination may be made of which of the left and right outer spray sections 200A, 210A and an intermediate spray section 72 between the left and right outer spray sections 200A, 210A should be deactivated. Such determination may be based on a potential overlap of a portion of boom 7 with a previously sprayed portion of the agricultural field as a potential overlap spray section. This may be a portion of the boom 7 and corresponding spray section(s) 72 that is aligned with a previously sprayed section of an agricultural field when the sprayer 15 is traveling along its travel path.

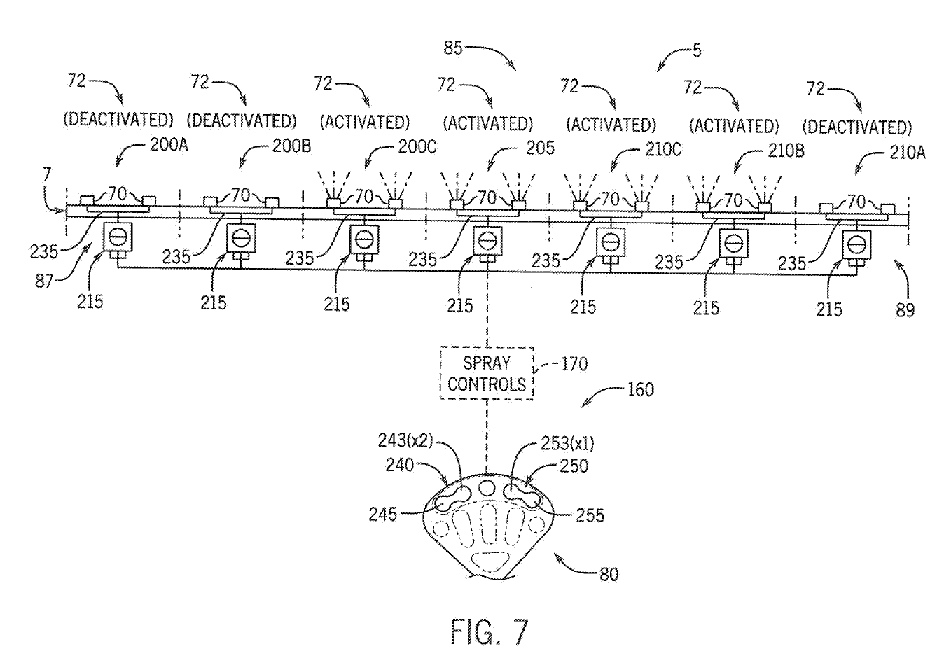

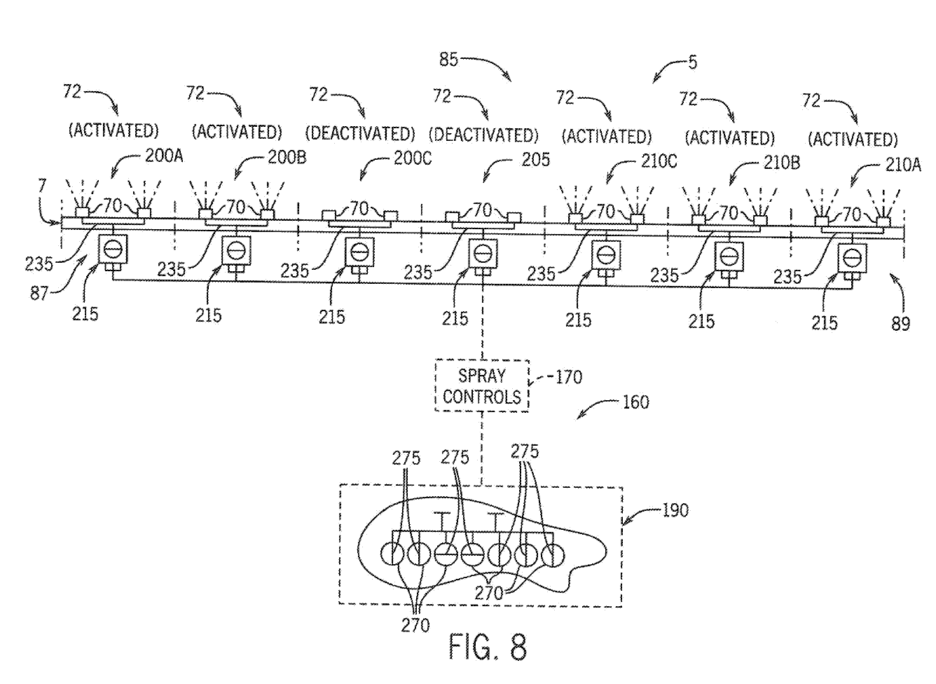

Referring now to FIG. 7, sprayer boom system 5 is shown with two deactivated spray sections 72 at the left-hand side of left boom arm 87. This was done by pressing left-start deactivation button 243 of grip 180 twice, as represented by the parenthetical (x2). One spray section 72 is deactivated at the right-hand side of right boom arm 89. This is done by pressing right-start deactivation button 253 of grip 180 once, as represented by the parenthetical (x1). Referring now to FIG. 8, sprayer boom system 5 is shown with two deactivated intermediate spray sections 72, toward the middle of boom 7. This was done by pressing the middle spray section valve button 270 corresponding to center spray section 205 to rotate the bar 275 to illustrate a closed position of the corresponding spray section feed valve 215. The same left inner spray section 200C.

Many changes and modifications could be made to the invention without departing from the spirit thereof. The scope of these changes will become apparent from the appended claims.

We claim:

1. An applicator boom system with multi-direction section activation control, the applicator boom system comprising:
a boom extending transversely relative to a self-propelled agricultural applicator, the boom having a boom center section for supporting the boom from the self-propelled agricultural applicator, a left boom arm extending to the left away from the center section, and a right boom arm extending to the right away from the center section;
an application system having multiple application sections defined along the boom selectively delivering product stored at the self-propelled agricultural applicator for release onto an agricultural field at locations corresponding to positions of the multiple application sections, the multiple application sections including:
multiple left boom arm application sections arranged at the left boom arm, the multiple left boom arm application sections including a left outer application section arranged at an outer end of the left boom arm farthest from the boom center section and a left inner application section arranged at an inner end of the left boom arm closest to the boom center section;
multiple right boom arm application sections arranged at the right boom arm, the multiple right boom arm application sections including a right outer application section arranged at an outer end of the right boom arm farthest from the boom center section and a right inner application section arranged at an inner end of the right boom arm closest to the boom center section; and
a center application section arranged at the boom center section; and
an application section control system controlling the application system to selectively activate and deactivate ones of the multiple application sections to selectively permit spray release of the product from activated ones of the multiple application sections and prevent application release of the product from deactivated ones of the multiple application sections, wherein the application section control system is configured to deactivate application sections according to a multi-pattern deactivation strategy with the multi-pattern deactivation strategy including,
a first deactivation pattern during which application sections are deactivated with a left-to-right deactivation direction pattern from the left outer application section toward the right outer application section;
a second deactivation pattern during which application sections are deactivated with a right-to-left deactivation direction pattern from the right outer application section toward the left outer application section, and
a third deactivation pattern during which application sections are deactivated with an intermediate bi-directional pattern from an intermediate application section between the left and right outer application sections toward at least one of the left and right outer application sections.

2. The applicator boom system of claim 1 wherein the applicator is a sprayer with the application system defining a spray system, the application section control system defines a spray section control system, and the respective application sections define spray sections, and wherein the spray section control system is configured to activate spray sections according to a multi-pattern activation strategy with the multi-pattern activation strategy including,
a first activation pattern during which spray sections are activated with a right-to-left activation direction;
a second activation pattern during which spray sections are activated with a left-to-right activation direction; and
a third activation pattern during which spray sections are activated with an intermediate bi-directional pattern from an intermediate spray section between the left and right outer spray sections toward at least one of the left and right outer spray sections.

3. The applicator boom system of claim 2 wherein the spray section control system further comprises a first set of spray deactivation/activation buttons configured for deactivating and activating the spray sections according to the first deactivation and activation patterns and a second set of spray deactivation/activation buttons configured for deactivating and activating the spray sections according to the second deactivation and activation patterns.

4. The applicator boom system of claim 3 wherein the first set of spray deactivation/activation buttons includes a left-start deactivation button configured so that sequentially pressing the left-start deactivation button sequentially deactivates the spray sections from the left outer spray section toward the right outer spray section.

5. The applicator boom system of claim 3 wherein the first set of spray deactivation/activation buttons includes a right-start activation button configured so that sequentially pressing the right-start activating button sequentially activates the spray sections from a right-most deactivated spray section toward the left outer spray section.

6. The applicator boom system of claim 3 wherein the second set of spray deactivation/activation buttons includes a right-start deactivation button configured so that sequentially pressing the right-start deactivation button sequentially deactivates the spray sections from the right outer spray section toward the left outer spray section.

7. The applicator boom system of claim 3 wherein the second set of spray deactivation/activation buttons includes a left-start activation button configured so that sequentially pressing the left-start activating button sequentially activates the spray sections from a left-most deactivated spray section toward the right outer spray section.

8. The applicator boom system of claim 3 wherein the first and second sets of spray deactivation/activation buttons are arranged at a grip of a joystick control of the self-propelled agricultural sprayer.

9. The applicator boom system of claim 8 wherein the first set of spray deactivation/activation buttons are defined by a pair of pad segments of a first spray control button and the second set of spray deactivation/activation buttons are defined by a pair of pad segments of a second spray control button.

10. The applicator boom system of claim 9 wherein the spray section control system further comprises a full activation button configured to activate all of the spray sections in a single actuation of the full activation button.

11. The applicator boom system of claim 2 wherein the spray section control system further comprises a third set of spray deactivation/activation buttons configured for deactivating and activating the spray sections according to the third deactivation and activation patterns.

12. The applicator boom system of claim 11 wherein the third set of spray deactivation/activation buttons includes multiple spray section valve buttons corresponding to the multiple sections of the boom system, wherein the each of the multiple spray sections can be deactivated and activated independently of the other spray sections.

13. The applicator boom system of claim 12 wherein the third set of spray deactivation/activation buttons is defined by graphical buttons displayed on a touchscreen of the spray section control system, wherein each of the graphical buttons of the third set of spray deactivation/activation buttons changes visually to provide a visual indication of a closed condition or an open condition of a spray section feed valve feeding the respective spray section with the visual indication of the closed condition and open condition of the spray section feed valve corresponding to a deactivated and activated condition of the respective spray section.

14. The applicator boom system of claim 1 wherein each of the multiple applicator sections includes multiple spray nozzles.

15. A method of controlling a spray delivery pattern from a self-propelled agricultural sprayer, the method comprising:
initiating a spraying session of a self-propelled agricultural sprayer, including activating all of multiple spray sections of a self-propelled agricultural sprayer, wherein the multiple spray sections include a left outer spray section arranged at an outer end of a left boom arm and a right outer spray section arranged at an outer end of a right boom arm;
deactivating one of the left and right outer spray sections as an initial spray deactivation event during a first spray deactivation procedure of the spraying session; and
deactivating the other one of the left and right outer spray sections as an initial spray deactivation event during a second spray deactivation procedure of the spraying session.

16. The method of claim 15 wherein,
during the first deactivation procedure, multiple spray sections are deactivated according a first deactivation pattern during which spray sections are deactivated with a left-to-right deactivation direction pattern from the left outer spray section toward the right outer spray section; and
during the second deactivation procedure, multiple spray sections are deactivated according a second deactivation pattern during which spray sections are deactivated with a right-to-left deactivation direction pattern from the right outer spray section toward the left outer spray section.

17. The method of claim 16 further comprising performing a third deactivation procedure, during which spray sections are deactivated with an intermediate bi-directional pattern from an intermediate spray section between the left and right outer spray sections toward at least one of the left and right outer spray sections.

18. A method of controlling a spray delivery pattern from a self-propelled agricultural sprayer, the method comprising:
initiating a spraying session of a self-propelled agricultural sprayer to spray a product on an agricultural field, including activating all of multiple spray sections of a boom of a self-propelled agricultural sprayer, wherein the multiple spray sections include a left outer spray section arranged at an outer end of a left boom arm of the boom, a right outer spray section arranged at an outer end of a right boom arm of the boom, and an intermediate spray section arranged between the left and right outer spray sections;
determining which of the left outer spray section, the right outer spray section, and the intermediate spray section should be deactivated during a deactivation procedure of the spraying session based on a potential overlap of a portion of the boom with a previously sprayed portion of the agricultural field as a potential overlap spray section; and
deactivating one of the left outer spray section, the right outer spray section, and the intermediate spray section corresponding to the determined potential overlap spray section.

19. The method of claim 18 further comprising,
performing a first deactivation procedure by sequentially deactivating multiple spray sections according to a left-to-right deactivation direction pattern starting by deactivating the left outer spray section and deactivating adjacent spray sections toward the right outer spray section;
performing a second deactivation procedure by sequentially deactivating multiple spray sections according to a right-to-left deactivation direction pattern starting by deactivating the right outer spray section and deactivating adjacent spray sections toward the left outer spray section; and
performing a third deactivation procedure by sequentially deactivating multiple spray sections according to an intermediate bi-directional pattern starting by deactivating the intermediate spray section and deactivating adjacent spray sections toward at least one of the left and right outer spray sections.
